(19) United States
(12) Patent Application Publication
(10) Pub. No.: US 2006/0158118 A1
(43) Pub. Date: Jul. 20, 2006

(54) Plasma display device

(76) Inventors: Sok-San Kim, Suwon-si (KR); Tae Kyoung Kang, Suwon-si (KR); Pil-Ho Jung, Suwon-si (KR)

Correspondence Address: LEE & MORSE, P.C., 1101 WILSON BOULEVARD, SUITE 2000, ARLINGTON, VA, 22209, US

(21) Appl. No.: 11/332,151

(22) Filed: Jan. 17, 2006

(30) Foreign Application Priority Data
Jan. 19, 2005 (KR) 10-2005-0004978

(51) Int. Cl. H01J 61/30

(52) U.S. Cl. 313/634

(57) ABSTRACT

A plasma display device including a plasma display panel having a front substrate and a rear substrate, wherein an inner surface of the front substrate is disposed to face an inner surface of the rear substrate, a flexible filter disposed adjacent to an outer surface of the front substrate, and a first adhesive member disposed along an edge of the flexible filter and fixing the flexible filter in place.

### BACKGROUND OF THE INVENTION

1. Field of the Invention

The present invention relates to a plasma display device. In particular, the present invention relates to a plasma display device in which a directly-attaching filter is attached to the front surface of a panel using an adhesive member.

2. Description of the Related Art

Plasma display devices are a type of flat panel display devices that display images using a gas discharge phenomenon. The plasma display devices may exhibit superior display performance in terms of display capacity, luminance, contrast, afterimage, and viewing angle, and are thin and suited to large screen sizes. These meritorious characteristics have put plasma display devices in the spotlight as one of the next-generation large, flat panel display devices in line to replace cathode ray tubes. Typically, plasma display devices include a plasma display panel (PDP) formed of glass substrates and a chassis base supporting the PDP.

FIG. 1 illustrates an exploded perspective view of a typical plasma display device. Referring to FIG. 1, a PDP in the plasma display device may include a front substrate 110 and a rear substrate 120. The PDP may be fixed to a chassis base 30. A plurality of circuit board assemblies (not shown) may be installed on a rear surface of the chassis base 30. A first signal transmission cable 31 may be electrically connected to an electrode formed on the front substrate 110. A second signal transmission cable 32 may be electrically connected to an electrode formed on the rear substrate 120. The first and second signal transmission cables 31, 32 may extend to the rear surface of the chassis base 30 and may be connected to electronic parts (not shown) of the circuit board assemblies fixed to the chassis base 30.

A glass filter 14 may be arranged in front of the front substrate 110 and fixed to a front case 10 by a filter holder 15. The glass filter 14 and the front substrate 110, except for the edge thereof, may be exposed through a window 12 formed in the front case 10. The PDP fixed to the chassis base 30 may be installed in a space formed when the front case 10 is assembled to a rear case 40.

The glass filter 14 may be formed by applying multiple coating layers to the surface of a glass sheet, and may provide a variety of functions. For example, a mesh film may be formed of, e.g., a metal material such as copper that exhibits superior conductivity, thus providing an electromagnetic shielding function. Various physical and chemical treatments that may block near infrared and/or ultraviolet light, prevent irregular reflections, and improve contrast may be added to the surface of the glass filter 14.

There is a demand for large plasma display devices. However, increasing the size of the PDP increases the size of the glass filter accordingly. Thus, the weight of the glass filter 14 and the weight of the filter holder 15 that holds the glass filter 14 increases. In turn, the manufacturing cost increases and the handling of the glass filter 14 becomes more difficult.

To overcome the above problems, the use of a light flexible filter, instead of the glass filter 14, has been suggested. The flexible filter may be based on a flexible material such as a polymer film, and one or more coatings capable of providing predetermined functions may be applied to the flexible material. However, when the flexible filter is applied to the plasma display device, it may be difficult to stably hold the flexible filter. In particular, if the flexible filter is directly attached to the surface of the front substrate of the PDP, the flexible filter may become detached due to heat generated from the PDP.

### SUMMARY OF THE INVENTION

The present invention is therefore directed to a plasma display device, in which a directly-attaching filter is attached to the front surface of a plasma display panel using an adhesive member, which substantially overcomes one or more of the problems due to the limitations and disadvantages of the related art.

It is therefore a feature of an embodiment of the present invention to provide a plasma display device in which a flexible filter remains fixed in place under varying environmental conditions such as high temperatures, low temperatures, high humidity, etc.

It is therefore another feature of an embodiment of the present invention to provide a plasma display device including one or more adhesive members that fix a flexible filter in place, and which may also fix signal or other cables in place.

It is therefore yet another feature of an embodiment of the present invention to provide a plasma display device including one or more adhesive members that fix a flexible filter in place, and which may also prevent the intrusion of foreign materials.

At least one of the above and other features and advantages of the present invention may be realized by providing a plasma display device including a plasma display panel having a front substrate and a rear substrate, wherein an inner surface of the front substrate is disposed to face an inner surface of the rear substrate, a flexible filter disposed adjacent to an outer surface of the front substrate, and a first adhesive member disposed along an edge of the flexible filter and fixing the flexible filter in place.

The first adhesive member may be a continuously formed member. A plurality of intermittently formed first adhesive members may be disposed along the edge of the flexible filter and fix the flexible filter in place. The first adhesive member may include a silicone or epoxy material. The plasma display device may further include a chassis base arranged adjacent to a rear surface of the plasma display panel, a circuit board assembly provided on a surface of the chassis base, on which a plurality of electronic parts are installed, and a signal transmission cable connected between electrodes formed on inner surfaces of the front and rear substrates and the circuit board assembly.

A height of the front substrate may be less than a height of the rear substrate, the plasma display device further may include a second adhesive member, and the second adhesive member may be disposed on the inner surface of the rear substrate and fix a signal transmission cable in place. The second adhesive member may be a continuously formed member. A plurality of intermittently formed second adhesive members may be disposed on the inner surface of the rear substrate and may fix the signal transmission cable in place. The second adhesive member may include a silicone or epoxy material.

The plasma display device may further include a conductive web formed on the flexible filter, a chassis base, and a conductive cable connecting the chassis base to the conductive web, wherein the conductive cable is fixed in place by the first adhesive member and the second adhesive member. The second adhesive member may be disposed along at least one of an upper and lower edge of the inner surface of the rear substrate. The second adhesive member may be disposed adjacent to at least one of a top side surface and a bottom side surface of the front substrate. The signal transmission cable may couple electrodes of the rear substrate to a circuit assembly, the circuit assembly disposed to the rear of the plasma display panel. The plasma display device may further include a chassis base arranged adjacent to a rear surface of the plasma display panel, wherein the circuit assembly may be mounted to a rear surface of the chassis base.

A height of the flexible filter may be less than a height of the front substrate, and the first adhesive member may be disposed on a front surface of the flexible filter, on a side surface of the flexible filter, and on the outer surface of the front substrate. Height and width dimensions of the flexible filter may be substantially the same as height and width dimensions of the front substrate, and the first adhesive member may be disposed on a front surface of the flexible filter and on the inner surface of the rear substrate. A height of the front substrate may be less than a height of the rear substrate, and the first adhesive member may fix a signal transmission cable in place on the inner surface of the rear substrate.

The plasma display device may further include a conductive web formed on the flexible filter, a chassis base, and a conductive cable connecting the chassis base to the conductive web, wherein the conductive cable may be fixed in place by the first adhesive member. The conductive web may be a conductive metal web. The conductive cable may extend under the first adhesive member.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an exploded perspective view of a typical plasma display device;

FIG. 2 illustrates an exploded perspective view of a plasma display device according to an embodiment of the present invention;

FIG. 3 illustrates a cross-section of a plasma display device according to another embodiment of the present invention;

FIG. 4 illustrates a conductive cable connection between a web on the filter and a chassis base; and

FIG. 5 illustrates a cross-section of a plasma display device according to yet another embodiment of the present invention.

### DETAILED DESCRIPTION OF THE INVENTION

Korean Patent Application No. 10-2005-0004978, filed on Jan. 19, 2005, in the Korean Intellectual Property Office, and entitled, “Plasma Display Device,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

According to the present invention, a plasma display device may use a flexible film instead of a glass filter, thus decreasing the overall weight of the plasma display device and enabling the elimination of additional structures associated with conventional filters. The flexible filter may be directly attached to the front substrate of the PDP using one or more adhesive members formed of, e.g., silicone or epoxy materials. Thus, deterioration of adhesion between the filter and the PDP due to heat generated by the PDP may be reduced or prevented. Furthermore, the silicone or epoxy material may assist the dissipation of heat, and noise may be additionally reduced. Also, the flexible filter may be maintained in position under varying environmental conditions, e.g., high temperatures, low temperatures, high humidity, etc. Further, the adhesive member may reduce or prevent the intrusion of foreign materials.

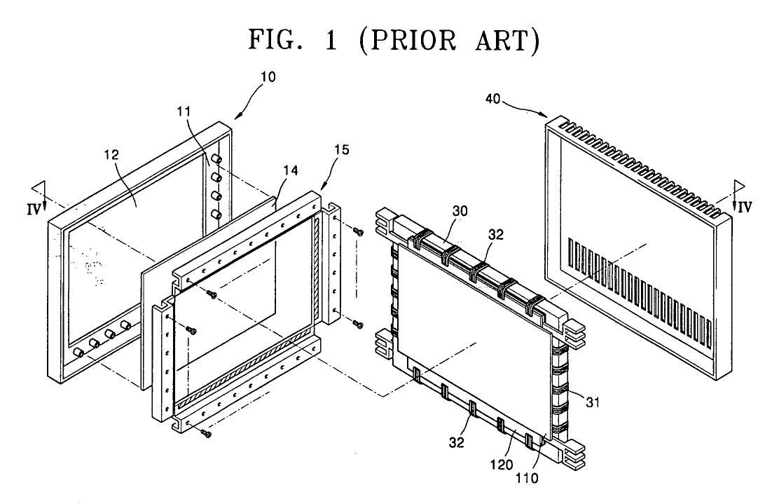

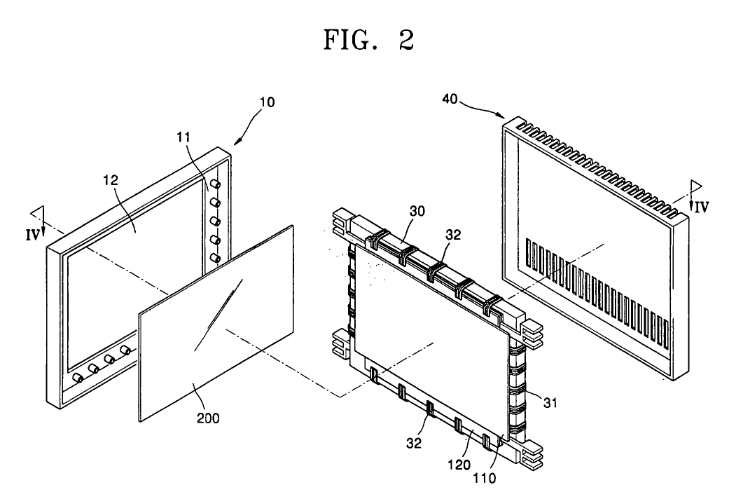

FIG. 2 illustrates an exploded perspective view of a plasma display device according to an embodiment of the present invention. In FIG. 2, the same reference numerals as those shown in FIG. 1 indicate the same constituent elements having substantially the same function. Referring to FIG. 2, the plasma display device according to this embodiment of the present invention may include a PDP having the front substrate 110 and the rear substrate 120, the chassis base 30 for holding the PDP, a flexible filter 200 directly attached to the surface of the front substrate 110, and the front and rear cases 10, 40, which may be coupled to each other to form an inner space where the chassis base 30 and other components are installed.

The first signal transmission cable 31 may electrically connect an electrode formed on the inner surface of the front substrate 110 to the electronic parts on the circuit board assemblies (not shown) installed on the rear surface of the chassis base 30. The second signal transmission cable 32 may electrically connect an electrode formed on the inner surface of the rear substrate 120 to the electronic parts on the circuit board assemblies (not shown) installed on the rear surface of the chassis base 30.

The flexible filter 200 may be attached to the surface of the front substrate 110. The flexible filter 200 may include coatings, layers, etc., to provide electromagnetic shielding and infrared and/or ultraviolet light blocking, to prevent irregular reflections, and to improve contrast. For example, a film, e.g., a plastic film, may be used that has a surface to which various physical and chemical processes are applied. In detail, a conductive web to shield electromagnetic radiation may be formed on the surface of the film, a dye capable of blocking light of a particular wavelength band may be coated on the surface of the film, and fine scratches may be formed on the surface of the film to prevent the reflection of the external light.

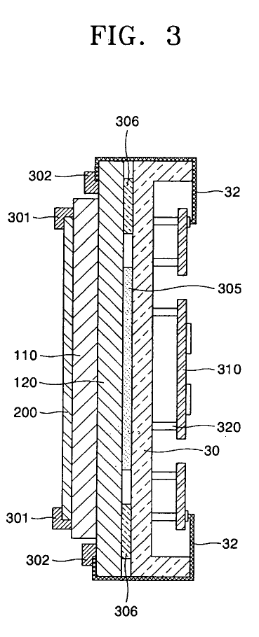

FIG. 3 illustrates a cross-section of a plasma display device according to another embodiment of the present invention. Referring to FIG. 3, the front substrate 110 and the rear substrate 120 may be coupled to each other to form the PDP. The chassis base may be arranged at the rear surface of the rear substrate 120. The rear surface of the rear substrate 120 and a surface of the chassis base 30 may be attached to each other through an adhesive member 306, e.g., an adhesive tape. A heat radiation member 305 may serve to dissipate heat generated during the operation of the PDP and may transfer heat to the chassis base 30.

A circuit board assembly 310 may be assembled to the rear surface of the chassis base 30 via a boss or standoff 320. Multiple electronic parts may be installed on the surface of the circuit board assembly 310. The second signal transmission cable 32 may connect a transparent electrode (not shown), which is formed on the inner surface of the rear substrate 120 and extends to the edge thereof, to a circuit formed on the circuit board assembly 310. Although only the second signal transmission cable 32 with respect to the rear surface substrate 120 is shown in the drawing, the first signal transmission cable 31 coupled to the front substrate 110, as illustrated in FIG. 2, may be similarly provided. The first and second signal transmission cables 31, 32 may be coupled to the inner surfaces of the respective substrates, i.e., the surfaces of the substrates that face each other.

The flexible filter 200 may be attached to the outer surface of the front substrate 110 using a first adhesive member 301. The first adhesive member 301 may include, e.g., a silicone or epoxy material. The area of the flexible filter 200 may be less than that of the front substrate 110. That is, for example, the height of the flexible filter may be less than the height of the front substrate. Thus, the first adhesive member 301 may be disposed along the edge of the flexible filter 200 and the edge of the outer surface of the front substrate 110. The first adhesive member 301 may be, e.g., coated in place.

A second adhesive member 302 may be used to fix the second signal transmission cable 32 in place. The second adhesive member 302 may be disposed to cover the second signal transmission cable 32 along the edge of the rear substrate 120. The second adhesive member 302 may be, e.g., coated in place. The second adhesive member 302 may be used to fix in place the first signal transmission cable 31, which is connected to the rear substrate 120. The second adhesive member 302 may include, e.g., a silicone or epoxy material.

The first adhesive member 301 may be continuously or intermittently formed along the edge of the flexible filter 200 and the edge of the front substrate 110. The first adhesive member 301 may be selectively formed on the upper, lower, left, and/or right edges of the front substrate 110. For example, the first adhesive member 301 may be selectively formed only on the upper and lower edges.

The second adhesive member 302 may be continuously or intermittently formed along the edge of the inner surface of the rear substrate 120, i.e., along the top and bottom edges of the rear substrate 120 in FIG. 3, and along the edge of the inner surface of the front substrate 110 (not shown in FIG. 3). The second adhesive member 302 may be formed only on the upper and lower edges of the inner surface of the rear substrate 120, where the second signal transmission cable 32 is connected, and on the left and right edges of the inner surface of the front substrate 110, where the first signal transmission cable 31 is connected (not shown in FIG. 3).

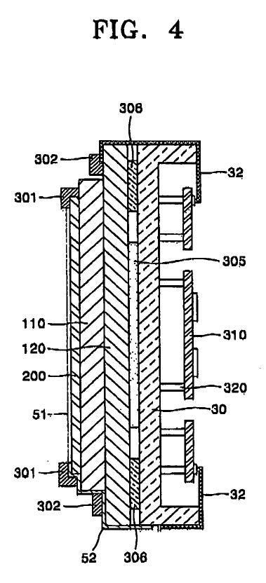

FIG. 4 illustrates a conductive cable connection between a web on the filter and the chassis base 30. Referring to FIG. 4, a conductive web 51, e.g., a conductive metal web, may be provided for shielding electromagnetic radiation. To ground the conductive web 51, a conductive ground cable may be extended across the first and second adhesive members 301 and 302. For example, a conductive cable 52 may be connected to the conductive web 51 and to the chassis base 30, and may traverse the edges of the front substrate 110 and the second substrate 120. The conductive cable 52 may be extended between the first adhesive member 301 and the front substrate 110, and between the second adhesive member 302 and the rear substrate 120, as illustrated in the lower portion of FIG. 4. That is, the first and second adhesive members 301, 302 may overlie the conductive cable 52. Thus, the conductive cable 52 may be maintained in a fixed position by the first and second adhesive members 301 and 302.

Where silicone or epoxy materials are used as the first and/or second adhesive members 301, 302, these materials may maintain their adhesive force even though exposed to the heat generated by the PDP. That is, even when high heat is generated during the operation of the PDP, the adhesive force may not deteriorate, thereby reducing or eliminating the likelihood that the flexible filter 200 will become detached. Also, since silicone and epoxy materials may perform a heat dissipation function, e.g., due to the inclusion of thermally conductive fillers, etc., the use of these materials may be provide an additional benefit by effecting the dissipation of heat from the PDP. Furthermore, the use of the first and second adhesive members 301 and 302 may reduce or prevent the intrusion of foreign materials. In particular, the intrusion of foreign materials between the flexible filter 200 and the front substrate 110 may be reduced or prevented.

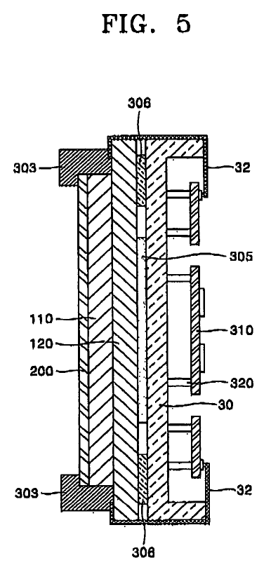

FIG. 5 illustrates a cross-section of a plasma display device according to yet another embodiment of the present invention. Referring to FIG. 5, the area of the flexible filter 200 may be substantially the same as that of the front substrate 110. That is, the height and width of the flexible filter may be substantially the same as the height and width of the front substrate. Thus, the edges of the flexible filter 200 and the front substrate 110 may be matched, i.e., they may be coextensive. In this embodiment, an adhesive member 303 may be disposed along the edge of the flexible filter 200 on the front (outer) surface of the front substrate 110 and along the edge of the inner surface of the rear substrate 120. The adhesive member 303 disposed on the inner surface of the rear substrate 120 may be disposed to cover the second signal transmission cable 32, so as fix the position of the second signal transmission cable 32. That is, the adhesive member 303 may be disposed along a front peripheral portion of the PDP, in particular along the upper and lower edges of the outer surface of the front substrate 110 and the inner surface of the rear substrate 120, to fix both the flexible filter 200 and the second signal transmission cable 32 in place. The adhesive member 303 may prevent the intrusion of foreign materials between the front substrate 110 and the rear substrate 120, and between the front substrate 110 and the flexible filter 200.

A conductive cable (not shown) may be connected to a conductive web formed on the flexible filter 200 in a similar fashion to that described above in connection with FIG. 4. The conductive cable may be extended to the chassis base 30 between the adhesive member 303 and the side surfaces of the front and rear substrates 110 and 120, thus fixing the conductive cable in position. The conductive cable may ground current associated with electromagnetic radiation flowing in the conductive metal web.

Another adhesive member (not shown) may be used for the left and right edges of the PDP, where the first signal transmission cable 31 may be connected to the inner surface of the front substrate 110. A silicone or epoxy material may be similarly used for this other adhesive member.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device comprising:
a plasma display panel having a front substrate and a rear substrate, wherein an inner surface of the front substrate is disposed to face an inner surface of the rear substrate;
a flexible filter disposed adjacent to an outer surface of the front substrate; and
a first adhesive member disposed along an edge of the flexible filter and fixing the flexible filter in place.

2. The plasma display device as claimed in claim 1, wherein the first adhesive member is a continuously formed member.

3. The plasma display device as claimed in claim 1, wherein a plurality of intermittently formed first adhesive members are disposed along the edge of the flexible filter and fix the flexible filter in place.

4. The plasma display device as claimed in claim 1, wherein the first adhesive member includes a silicone or epoxy material.

5. The plasma display device as claimed in claim 1, further comprising:
a chassis base arranged adjacent to a rear surface of the plasma display panel;
a circuit board assembly provided on a surface of the chassis base, on which a plurality of electronic parts are installed; and
a signal transmission cable connected between electrodes formed on inner surfaces of the front and rear substrates and the circuit board assembly.

6. The plasma display device as claimed in claim 1, wherein a height of the front substrate is less than a height of the rear substrate,
the plasma display device further includes a second adhesive member, and
the second adhesive member is disposed on the inner surface of the rear substrate and fixes a signal transmission cable in place.

7. The plasma display device as claimed in claim 6, wherein the second adhesive member is a continuously formed member.

8. The plasma display device as claimed in claim 6, wherein a plurality of intermittently formed second adhesive members are disposed on the inner surface of the rear substrate and fix the signal transmission cable in place.

9. The plasma display device as claimed in claim 6, wherein the second adhesive member includes a silicone or epoxy material.

10. The plasma display device as claimed in claim 6, further comprising:
a conductive web formed on the flexible filter;
a chassis base; and
a conductive cable connecting the chassis base to the conductive web, wherein the conductive cable is fixed in place by the first adhesive member and the second adhesive member.

11. The plasma display device as claimed in claim 6, wherein the second adhesive member is disposed along at least one of an upper and lower edge of the inner surface of the rear substrate.

12. The plasma display device as claimed in claim 11, wherein the second adhesive member is disposed adjacent to at least one of a top side surface and a bottom side surface of the front substrate.

13. The plasma display device as claimed in claim 6, wherein the signal transmission cable couples electrodes of the rear substrate to a circuit assembly, the circuit assembly disposed to the rear of the plasma display panel.

14. The plasma display device as claimed in claim 13, further comprising a chassis base arranged adjacent to a rear surface of the plasma display panel, wherein the circuit assembly is mounted to a rear surface of the chassis base.

15. The plasma display device as claimed in claim 1, wherein a height of the flexible filter is less than a height of the front substrate, and
the first adhesive member is disposed on a front surface of the flexible filter, on a side surface of the flexible filter, and on the outer surface of the front substrate.

16. The plasma display device as claimed in claim 1, wherein height and width dimensions of the flexible filter are substantially the same as height and width dimensions of the front substrate, and
the first adhesive member is disposed on a front surface of the flexible filter and on the inner surface of the rear substrate.

17. The plasma display device as claimed in claim 16, wherein a height of the front substrate is less than a height of the rear substrate, and
the first adhesive member fixes a signal transmission cable in place on the inner surface of the rear substrate.

18. The plasma display device as claimed in claim 1, further comprising:
a conductive web formed on the flexible filter;
a chassis base; and
a conductive cable connecting the chassis base to the conductive web, wherein the conductive cable is fixed in place by the first adhesive member.

19. The plasma display device as claimed in claim 18, wherein the conductive web is a conductive metal web.

20. The plasma display device as claimed in claim 18, wherein the conductive cable extends under the first adhesive member.
